(19) United States
(12) Patent Application Publication
(10) Pub. No.: US 2012/0292293 A1
(43) Pub. Date: Nov. 22, 2012

(54) METHOD OF MANUFACTURING AN INFLATOR

(75) Inventors: Christian Bibo, Taufkirchen (DE); Rainer Eggerdinger, Gars (DE); Karl Englbrecht, Erharting (DE); Thomas Nobach, Waldkraiburg (DE); Martin Oberstarr, Furth (DE); Johann Osl, Muhldorf (DE); Martin Sedlmeier, Vilsbiburg (DE); Stefan Siglreithmaier, Frabertsham (DE); Oskar Sponfeldner, Muhldorf (DE)

(73) Assignee: TRW Airbag Systems GmbH

(21) Appl. No.: 13/450,546

(22) Filed: Apr. 19, 2012

(30) Foreign Application Priority Data
May 19, 2011 (DE) 10 2011 102 064.4

(51) Int. Cl. B23K 11/00

(52) U.S. Cl. 219/117.1

(57) ABSTRACT

A method of manufacturing an inflator comprises the following steps: Providing a casing (12) that includes a tubular connecting portion (10) having a cylindrical wall (14), providing a closing member (19) that includes a closing portion (18) having a cylindrical contact surface (20) the cross-section of which has small oversize or undersize compared to the cross-section of the connecting portion (10), and axially pressing the closing member (19) into or onto the connecting portion (10) while simultaneously supplying electric current which flows between the cylindrical wall (14) and the contact surface (20) so that the closing member (19) is pressure-welded with the connecting portion (10).

### BACKGROUND OF THE INVENTION

The invention relates to a method of manufacturing an inflator.

Inflators are employed in vehicle occupant systems, for example for filling an airbag or for operating a belt tensioner.

In common designs a metallic casing body is filled with solid propellant and/or highly pressurized gases. The filling orifice must then be closed.

In DE 10 2006 051 170 B4 it is described to fill an inflator in a pressure chamber with pressurized gas and also to apply a closing member for the filling orifice in said pressure chamber. The connection between the closing member and the casing is performed by an electric welding process during which electric current flows through the casing and the closing member. In so doing, the material of the casing and the closing member is heated so strongly at the contact points that a welded joint is formed.

### SUMMARY OF THE INVENTION

It is the object of the invention to simplify the manufacture of an inflator and to reduce the manufacturing costs.

For the manufacture of an inflator a casing having a tubular connecting portion including a cylindrical wall is provided. It is noted that in accordance with the invention the term “cylindrical wall” is not restricted to a circular cylinder but may define any appropriate (annular) contour closed in it of a base area of the cylinder. A closing member is provided including a closing portion having a cylindrical contact surface the cross-section of which has small oversize or undersize compared to the cross-section of the connecting portion. The closing member is axially pressed into or onto the connecting portion while simultaneously electric current flowing between the cylindrical wall and the contact surface is supplied so that the closing member is pressure-welded with the connecting portion. This method is adapted, for instance, to quickly and safely close a filling orifice of an inflator by a closing member.

The method can be used both when the closing member has a diameter smaller than the connecting portion and vice versa, when the closing member has a diameter larger than the connecting portion and is pressed onto the connecting portion.

The wall thickness of the cylindrical wall is preferably smaller than the length of the connecting portion.

The wall thickness preferably amounts to 0.08 to 5 mm. A wall thickness of between 0.1 and 3 mm is preferred, especially the wall thickness amounts to 2.5 mm. The closing member preferably is configured to have a larger wall thickness than the cylindrical wall or exhibits a massive design.

The cross-section of the connecting portion can be polygonal, especially hexagonal. However, the cross-section may also be circular or oval.

In order to facilitate the press-in operation, the end of the connecting portion and/or the cylindrical contact surface may be beveled.

The axial length of the welded portion preferably corresponds to at most five times, especially at most 3.5 times the wall thickness of the cylindrical wall. Surprisingly, it turned out that already a welded connection of this type meets all requirements made to an inflator.

The casing and the closing member can be made of different materials. However, they can also be made of the same steel, for instance.

Preferably the casing is a tube and/or the closing member is a disc-shaped body.

The closing portion can exhibit an expanded axial end forming the cylindrical wall. This configuration facilitates filling the inflator and closing the orifice.

It is also possible for the connecting portion to have a radially inwardly extending integrally formed end face including an orifice the rim of which forms the cylindrical wall. This configuration permits to easily press in the closing member. In particular, in this case beveling of either of the two components can be dispensed with.

### BRIEF DESCRIPTION OF THE DRAWINGS

The invention shall be described in detail hereinafter by way of plural embodiments and the attached drawings, in which:

FIGS. 1 and 2 show a sectional view of a connecting portion and a closing member of an inflator before and after pressing in the closing member in accordance with a first embodiment of the method according to the invention;

FIGS. 3 and 4 show a sectional view of a connecting portion and a closing member of an inflator before and after pressing in the closing member in accordance with a second embodiment of the method according to the invention;

FIGS. 5 and 6 show a sectional view of a connecting portion and a closing member of an inflator before and after pressing in the closing member in accordance with a third embodiment of the method according to the invention;

FIGS. 7 and 8 show a sectional view of a connecting portion and a closing member of an inflator before and after pressing in the closing member in accordance with a fourth embodiment of the method according to the invention;

FIGS. 9 and 10 show a sectional view of a connecting portion and a closing member of an inflator before and after pressing in the closing member in accordance with a fifth embodiment of the method according to the invention; and

FIGS. 11 to 13 show a sectional view of a connecting portion and a dosing member of an inflator before and after pressing in the closing member in accordance with a sixth embodiment of the method according to the invention.

### DETAILED DESCRIPTION OF THE INVENTION

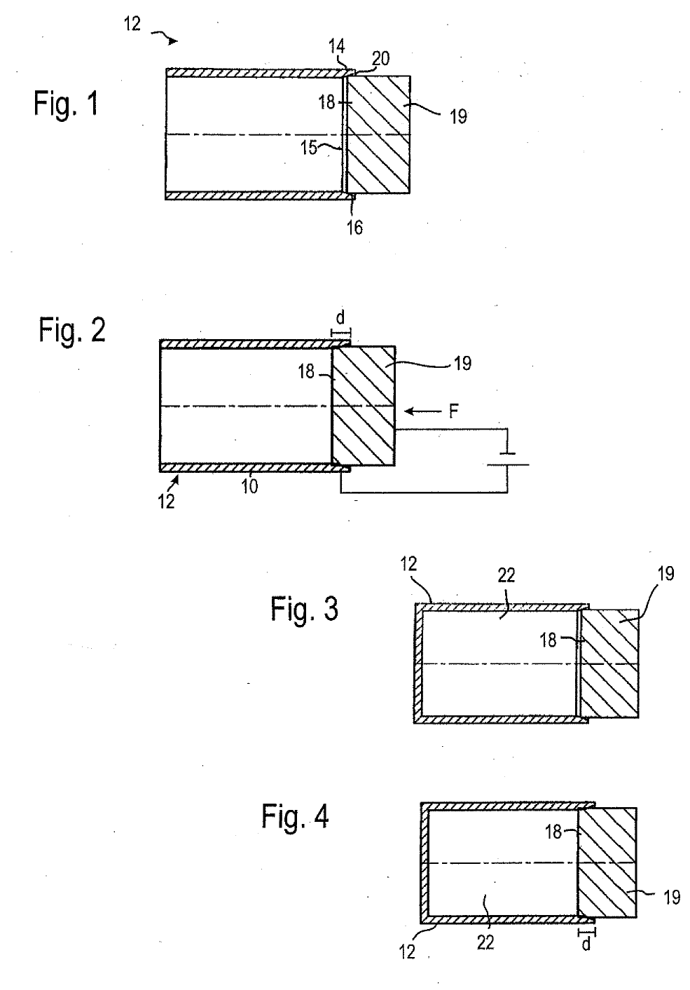

FIG. 1 illustrates a metallic tubular connecting portion 10 which is part of a casing 12 of an inflator not shown in detail and includes a cylindrical wall 14 having an orifice 15 located at the free axial end thereof.

The wall thickness of the cylindrical wall 14 in this example amounts to approx. between 0.1 and 5 mm.

For closing the casing 12 first of all a closing portion 18 of a closing member 19 not shown in detail is inserted in the orifice 15. The closing portion 18 is in the form of a disc-shaped component in this case.

The geometric shape of cross-section of the closing portion 18 is adapted to the cross-sectional area of the orifice 15. The closing portion 18 has small oversize compared to the orifice 15, however, so that it cannot be fully inserted into the orifice 15. This state is illustrated in FIG. 1.

The beveling 16 can be formed at the inserting end of the closing portion 18 or else at both components.

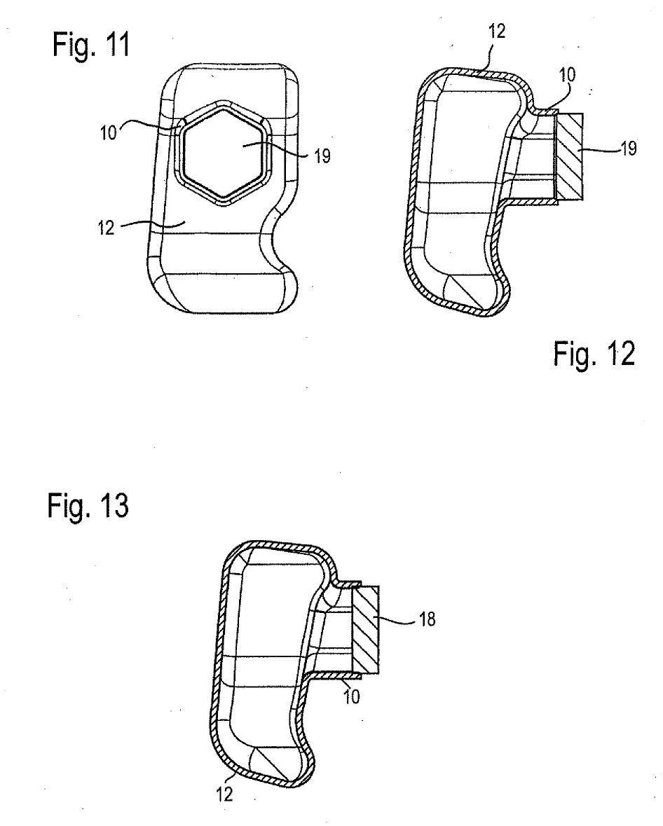

The cross-section may be circular, but also polygonal, especially hexagonal as shown in FIGS. 11 to 13.

Now electric current is made to flow through the closing member 19 and the cylindrical wall 14 of the connecting portion 10, as indicated in FIG. 2.

At the same time, a force F is exerted in axial direction on the closing member 19 and the latter is displaced into the orifice 15 of the connecting portion 10 by a predetermined measure d. This is possible because a cylindrical contact surface 20 of the closing member 18 and the cylindrical inner wall of the connecting portion 10 are heated by the current flow so strongly that a softening of the material takes place. Upon disconnection of the current flow the material re-solidifies so that a circumferential welded joint having the axial length d is formed along the cylindrical contact surface 20.

The inner cross-section of the cylindrical wall 14 is constant over the length d with the exception of the beveling 16.

As an option, the wall 14 can bulge outwardly at the outside in the area of the closing portion 18. In the preferred embodiment the outer geometry remains unchanged in the area of the closing portion 18.

In FIGS. 3 and 4 the tubular connecting portion 10 is closed at its second end face and in this way forms the entire casing 12 of the inflator. The conventional components of an inflator, such as a propellant of pyrotechnic material and/or pressurized gas (approx. 300 bar to 500 bar), for example argon and/or helium (not shown here), are introduced to the chamber 22 enclosed by the casing 12 before it is closed by the closing member 19.

FIG. 3 illustrates the state prior to closing and FIG. 4 illustrates the state after pressure-welding.

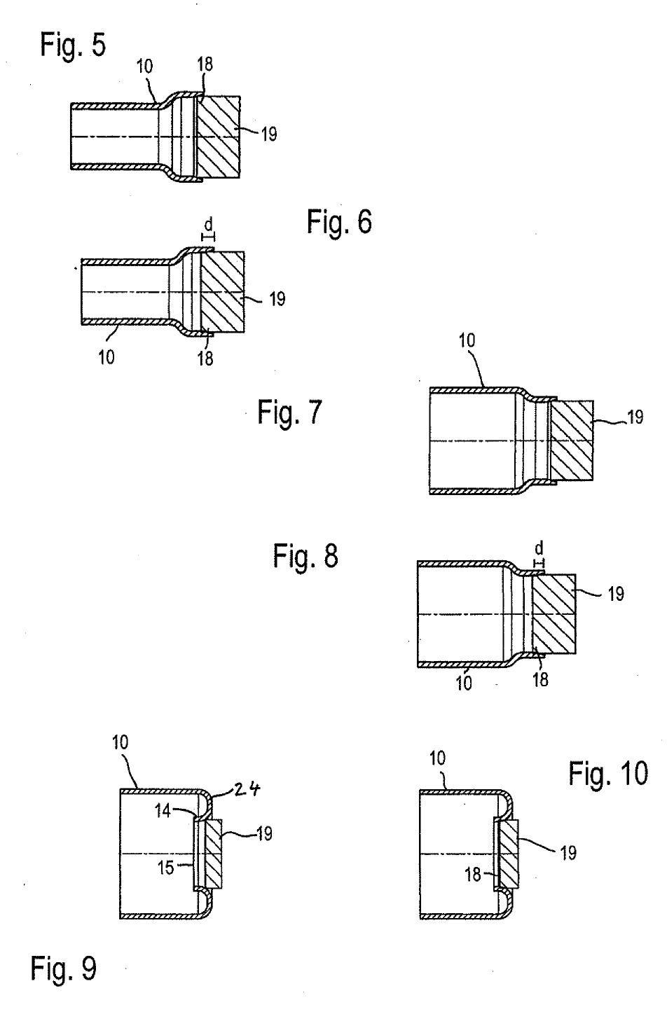

FIGS. 5 and 6 illustrate a connecting portion 10 which is radially expanded at its axial end. The axial length of the expanded area is larger than the inserting length d, as shown in FIG. 6.

On the other hand, in FIGS. 7 and 8 a connecting portion 10 is shown the axial end of which is radially tapered. In this case, too, the axial length of the tapering is larger than the inserting length d.

FIGS. 9 and 10 illustrate an embodiment in which the axial end of the connecting portion 10 is curved radially inwardly. in this way an end wall 24 is formed, while the actual axial end is located axially inside the connecting portion 10. By virtue of the curvature of the end wall 24 a beveling can be dispensed with in this case.

This configuration also has the advantage that the closing member 19 does not project that far from the axial end of the connecting portion 10 as in the case of the other embodiments.

FIGS. 11 to 13 illustrate a complete casing 12 of an inflator, the connecting portion 10 vertically projecting from a flat side wall. The cross-section of the connecting portion 10 has a hexagonal shape with rounded corners in this case. The cross-section of the closing portion 18 is adapted hereto. In this case, too, the cross-section of the closing portion 18 exhibits small oversize compared to the cross-section of the orifice of the connecting portion 10.

In each of the Figures only the closing portion 18 of the closing member 19 is represented. The remaining closing member 19 can have any suitable configuration.

Alternatively to pressing the closing member into the orifice of the connecting portion, the closing member could also be pressed onto the connecting portion. For this purpose, a recess may be provided in the closing portion so that the latter can be pushed onto the connecting portion. In such case the weld and the contact surface are correspondingly located on the radial outside of the closing portion and not, as in the case of the previously described embodiments, on the radial inside.

It is emphasized that the given values for thickness, inserting length, deformation at the inserting end etc. are applicable to all embodiments.

It is further noted that the afore-described invention with an inflator is niched in the field of a protection device for persons, especially a vehicle occupant system in which extreme safety is vital. In particular, such inflator usually includes a hollow not very massive container having a relatively soft rim of a connecting portion which has to be closed so that various requirements relating to the afore-mentioned safety can be met.

1. A method of manufacturing an inflator comprising the steps of:
providing a casing (12) that has a tubular connecting portion (10) including a cylindrical wall (14),
providing a closing member (19) that includes a closing portion (18) having a cylindrical contact surface (20) the cross-section of which exhibits small oversize or undersize compared to the cross-section of the connecting portion (10), and
axially pressing the closing member (19) into or onto the connecting portion (10) while simultaneously supplying electric current which flows between the cylindrical wall (14) and the contact surface (20) so that the closing member (19) is pressure-welded with the connecting portion (10).

2. The method according to claim 1, wherein the wall thickness of the cylindrical wall (14) is smaller than the length of the connecting portion (10).

3. The method according to claim 2, wherein the wall thickness amounts to 0.08 to 5 mm, preferably 0.1 to 3 mm, especially 2.5 mm.

4. The method according to claim 1, wherein the cross-section of the connecting portion (10) is polygonal, especially hexagonal.

5. The method according to claim 1, wherein the axial end of the connecting portion (10) and/or the cylindrical contact surface (20) are beveled.

6. The method according to claim 1, wherein the axial length (d) of the welded portion corresponds to at most 5 times, especially at most 3.5 times the wall thickness of the cylindrical wall (14).

7. The method according to claim 1, claim 1 the casing (12) and the closing member (19) are made of different materials.

8. The method according to claim 1, wherein the casing (12) is a tube and/or the closing portion (18) is a disc-shaped body.

9. The method according to claim 1, wherein the connecting portion (10) includes an expanded axial end that forms the cylindrical wall (14).

10. The method according to claim 1, wherein the connecting portion (10) includes a radially inwardly extending integrally formed end wall (24) having an orifice (15) the rim of which forms the cylindrical wall (14).
